(19) United States
(12) Patent Application Publication
(10) Pub. No.: US 2025/0301293 A1
(43) Pub. Date: Sep. 25, 2025

(54) COMMUNICATION CONTROL SYSTEM AND VEHICLE EXTERIOR ANTENNA DEVICE

(71) Applicant: AISIN CORPORATION, Kariya (JP)

(72) Inventors: Takaaki KOIZUMI, Kariya-shi (JP); Haruki TSUJI, Kariya-shi (JP)

(73) Assignee: AISIN CORPORATION, Kariya (JP)

(21) Appl. No.: 19/081,167

(22) Filed: Mar. 17, 2025

(30) Foreign Application Priority Data
Mar. 25, 2024 (JP) 2024-048115

(51) Int. Cl. H04W 4/80; B60R 25/24

(52) U.S. Cl. CPC H04W 4/80; B60R 25/24; B60R 2325/103

(57) ABSTRACT

A communication control system includes a communication unit that performs NFC communication with a key medium associated with a key unit of a vehicle, and a control unit that controls operation of the communication unit, in which the communication unit includes a storage that stores a unique ID of the key medium, a searcher that searches for a unique ID that matches the unique ID stored in the storage, when performing the NFC communication, and a notifier that notifies the control unit when the unique ID that matches the unique ID stored in the storage is searched for.

### CROSS REFERENCE TO RELATED APPLICATIONS

This application is based on and claims priority under 35 U.S.C. § 119 to Japanese Patent Application No. 2024-048115, filed on Mar. 25, 2024, the entire content of which is incorporated herein by reference.

### TECHNICAL FIELD

The present disclosure relates to a communication control system and a vehicle exterior antenna device that perform NFC communication.

### BACKGROUND DISCUSSION

In recent years, a technique for controlling a key unit of a vehicle with an electronic key via a key medium such as a card key or a mobile terminal has been used. As a technique related to such an electronic key, for example, there is a technique described in JP 2003-113565 A and JP 2023-178671 A of which source is described below.

JP 2003-113565 A describes a digital key system provided in a vehicle. The digital key system includes a reader that performs near-field communication with a digital key, and a controller that executes a preset function of the vehicle when communication with the digital key via the reader is successful. In the controller, a function to be executed is switched according to a result of success or failure of the communication with the digital key.

JP 2023-178671 A describes an authentication device that communicates with a key device and authenticates the key device with digital data. The authentication device is configured to identify a unique ID of the key device through communication with the key device and determine an authentication method on the basis of the unique ID.

The digital key system described in JP 2003-113565 A is configured such that a function to be executed can be switched according to a result of success or failure of communication with a digital key. The authentication device described in JP 2023-178671 A is configured to determine an authentication method on the basis of a result of communication with the key device. For this reason, in the digital key system described in JP 2003-113565 A and the authentication device described in JP 2023-178671 A, for example, when a plurality of card keys are held over, communication with each card key is required, and it takes time to start communication with a target card. In addition, because communication is performed with each of a plurality of cards, power consumption increases. Furthermore, because power is supplied for a long time until the communication is completed, lifetime of constituent components (electronic components) is shortened.

A need thus exists for a communication control system and a vehicle exterior antenna device which are not susceptible to the drawback mentioned above.

### SUMMARY

A communication control system includes a communication unit that performs NFC communication with a key medium associated with a key unit of a vehicle, and a control unit that controls operation of the communication unit, in which the communication unit includes a storage that stores a unique ID of the key medium, a searcher that searches for a unique ID that matches the unique ID stored in the storage, when performing the NFC communication, and a notifier that notifies the control unit when the unique ID that matches the unique ID stored in the storage is searched for.

A vehicle exterior antenna device includes a communication unit that performs NFC communication with a key medium associated with a key unit of a vehicle, in which the communication unit includes a storage that stores a unique ID of the key medium, a searcher that searches for a unique ID that matches the unique ID stored in the storage, when performing the NFC communication, and a notifier that notifies the control unit provided on the vehicle, when the unique ID that matches the unique ID stored in the storage is searched for.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view showing a vehicle provided with a communication control system;

FIG. 2 is a block diagram showing a configuration of the communication control system;

FIG. 3 is a diagram showing processing in the communication control system;

FIG. 4 is a diagram showing processing in the communication control system;

FIG. 5 is a flowchart showing processing in a communication unit; and

FIG. 6 is a flowchart showing processing in the communication unit.

### DETAILED DESCRIPTION

A communication control system according to the present disclosure is configured to be able to authenticate a key medium associated with a key unit of a vehicle in a short time. Hereinafter, a communication control system 1 of the present embodiment will be described. The communication control system 1, however, is not limited to the following embodiments, and various modifications may be made without departing from the gist of the modifications.

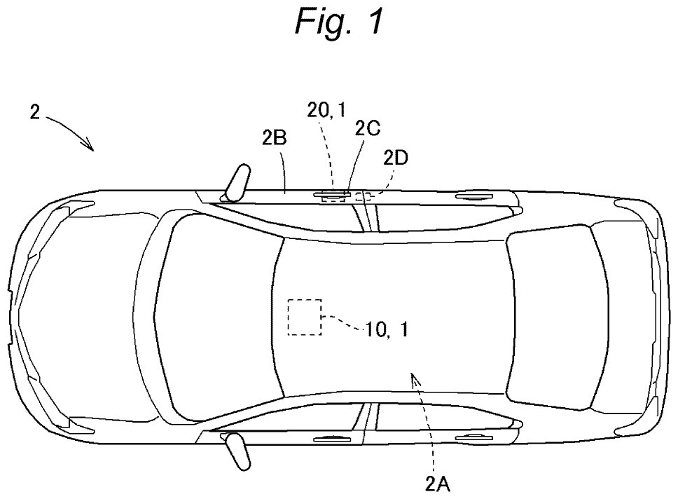

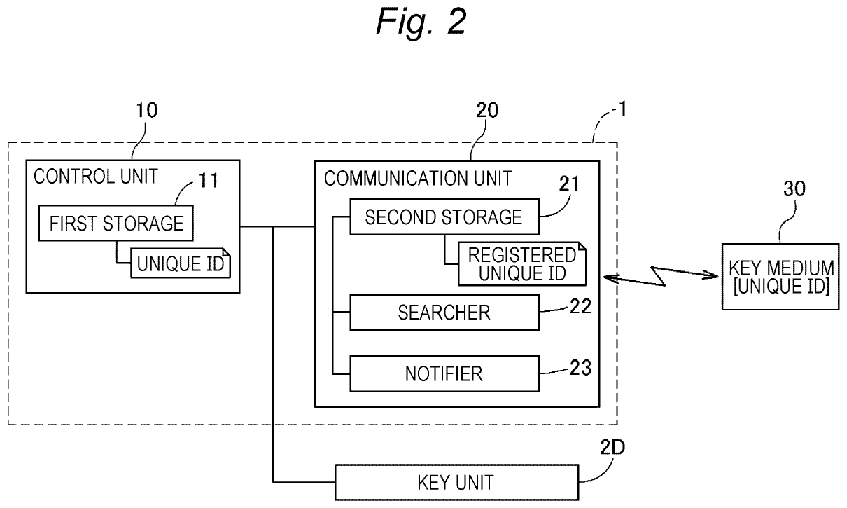

FIG. 1 is a diagram showing a vehicle 2 provided with a communication control system 1. FIG. 2 is a block diagram schematically showing a configuration of the communication control system 1. As shown in FIGS. 1 and 2, the communication control system 1 includes a control unit 10 and a communication unit 20. In the present embodiment, the control unit 10 is provided in a vehicle interior 2A. The communication unit 20 is provided on a door handle 2C of a door 2B of a driver seat.

As shown in FIG. 2, the control unit 10 includes a first storage 11 (an example of a “control unit-side storage”). The communication unit 20 includes a second storage 21 (an example of a “storage”), a searcher 22, and a notifier 23. Each of these functional units is constructed with hardware, software, or both with a CPU as a core member, in order to perform processing related to authentication with a key medium 30.

The communication unit 20 performs Near Field Communication (NFC) with the key medium 30 associated with a key unit 2D of the vehicle 2. The key unit 2D of the vehicle 2 is provided across the door 2B and a vehicle body of the vehicle 2. The key unit 2D can be switched between an unlocked state and a locked state. When the key unit 2D is in the unlocked state, the door 2B can be opened. When the key unit 2D is in the locked state, the door 2B cannot be opened. The key medium 30 associated with the key unit 2D corresponds to a medium storing an electronic key capable of switching the key unit 2D from the locked state to the unlocked state or vice versa. Specifically, the key medium 30 corresponds to a card key. The NFC communication is wireless communication performed at a short distance (several centimeters) using a frequency of 13.56 MHz. Therefore, the communication unit 20 performs wireless communication at a short distance (several centimeters) using a frequency of 13.56 MHz, with a card key storing an electronic key capable of switching the key unit 2D provided across the door 2B and vehicle body of the vehicle 2, from the locked state to the unlocked state or vice versa.

The control unit 10 controls operation of the communication unit 20. The control unit 10 and the communication unit 20 are communicably provided by, for example, controller area network (CAN) communication or local interconnect network (LIN) communication. Of course, the control unit 10 and the communication unit 20 can be provided in a communication mode different from the CAN communication and the LIN communication. The control unit 10 corresponds to a higher-order system that issues an operation instruction to the communication unit 20. Note that the control unit 10 and the communication unit 20 each include a communication controller in order to perform communication, but the communication controllers are omitted in FIG. 2.

A unique ID of the key medium 30 is stored in the first storage 11. The unique ID of the key medium 30 is assigned (set) for each key medium 30 associated with the key unit 2D of the vehicle 2 in which the control unit 10 is provided, and corresponds to a specific ID (a specific unique ID) that can identify the key medium 30. The unique ID does not include an electronic key capable of switching the key unit 2D from the locked state to the unlocked state or vice versa. The first storage 11 preferably stores the unique ID when the control unit 10 and the key unit 2D for the vehicle 2 are mounted.

The second storage 21 stores the unique ID of the key medium 30. In the present embodiment, the unique ID of the key medium is a unique ID stored in the first storage 11. Hereinafter, in order to facilitate understanding, the unique ID stored in the first storage 11 may be referred to as a registered unique ID. As described above, the unique ID stored in the first storage 11 is a specific ID stored in the first storage 11 and capable of identifying the key medium 30 associated with the key unit 2D of the vehicle 2 provided with the control unit 10. Content stored in the second storage 21 is managed by the control unit 10 (grasped by the control unit 10), and in a case where the unique ID stored in the first storage 11 is not stored in the second storage 21, the control unit 10 instructs the second storage 21 to store the unique ID stored in the first storage 11. The unique ID stored in this manner is treated as a registered unique ID.

When performing NFC communication, the searcher 22 preferentially searches for a unique ID that matches the unique ID (registered unique ID) stored in the second storage 21. “When performing NFC communication” means a case where some key medium 30 is brought in close to the communication unit 20. In this case, in order to determine whether or not the key medium 30 brought close is the key medium 30 associated with the key unit 2D of the vehicle 2, the control unit 10 searches for a unique ID that matches the unique ID (registered unique ID) stored in the second storage 21. Because the specific ID capable of identifying the key medium 30 associated with the key unit 2D of the vehicle 2 is stored in advance in the second storage 21, the searcher 22 does not need to inquire the control unit 10 for the unique ID to be searched for. Therefore, time required for search by the searcher 22 can be shortened as compared with a case of a system that requires an inquiry to the control unit 10. A search result from the searcher 22 is transmitted to the notifier 23.

In a case where a unique ID that matches the unique ID (registered unique ID) stored in the second storage 21 is searched for, the notifier 23 notifies the control unit 10 of the unique ID searched for. As described above, the search result from the searcher 22 is transmitted to the notifier 23. In a case where the search result indicates that the key medium 30 having a unique ID that matches the unique ID (registered unique ID) stored in the second storage 21 has been searched for, the notifier 23 notifies the control unit 10 of the unique ID searched for. The search result transmitted from the searcher 22 to the notifier 23 may be transmitted solely when the searcher 22 searches for the key medium 30 having the unique ID that matches the unique ID (registered unique ID) stored in the second storage 21, or may be transmitted even when the searcher 22 does not search for the key medium 30 having the unique ID that matches the unique ID (registered unique ID) stored in the second storage 21. In any case, when the key medium 30 having a unique ID that matches the unique ID (registered unique ID) stored in the second storage 21 is searched for by the searcher 22, the notifier 23 notifies the control unit 10 of the unique ID searched for. When the unique ID that matches the unique ID (registered unique ID) stored in the second storage 21 is not searched for by the searcher 22, the notifier 23 notifies the control unit 10 of the unique ID (registered unique ID) that is not searched for.

Accordingly, the communication control system 1 can authenticate the key medium 30 in a short time. Thus, the control unit 10 can instruct the key unit 2D to be switched from either the locked state or the unlocked state to the other.

Here, a plurality of key media 30 may be associated with one key unit 2D. That is, each of a plurality of persons may have a key medium 30 capable of switching the key unit 2D of a single vehicle 2 from either the locked state or the unlocked state to the other. The unique IDs of the plurality of key media 30 are different from each other. In this case, a plurality of unique IDs are stored in the first storage 11, and a plurality of unique IDs (registered unique IDs) are stored in the second storage 21.

In this case, among the plurality of unique IDs (registered unique IDs), the searcher 22 preferably searches for the unique ID that matches the unique ID (registered unique ID) selected on the basis of communication information including at least either the number of communications with the key medium 30 or a communication history. Specifically, among the plurality of unique IDs (registered unique IDs), the searcher 22 preferably searches for the unique ID that matches the unique ID (registered unique ID) sequentially from a unique ID (registered unique ID) having a larger number of communications with the key medium 30, or from a unique ID (registered unique ID) having a shorter time from a time point at which communication with the key medium 30 is made to a current time point. This makes it possible to quickly searches for the key medium 30 possessed by a person who frequently uses the vehicle 2 or the key medium 30 possessed by a person who has used the vehicle 2 most recently. Therefore, the communication control system 1 can authenticate the key medium 30 in a short time.

Here, it is also assumed that the key medium 30 that switches the key unit 2D from either the locked state or the unlocked state to the other is not a card key but a mobile terminal. In a case where a mobile terminal is used as the key medium 30, in communication between the communication unit 20 and the mobile terminal, a random ID set (generated) every time NFC communication is performed is used instead of the unique ID. Use of such a random ID is publicly known in the fields of NFC communication, and thus description thereof is omitted.

In a case where the key medium 30 does not have the specific unique ID, the searcher 22 requests the key medium 30 to notify the communication unit 20 of the unique ID of the key medium 30, and judges whether or not the unique ID is a random ID on the basis a part of a reception result corresponding to the request. The searcher 22 requests the key medium 30 present in a magnetic field, that is, the key medium 30 present in an area (an area of several centimeters from the communication unit 20) in which the communication unit 20 can perform NFC communication, to notify of the unique ID. The part of the reception result corresponds to a part of the unique ID transmitted from the key medium 30 in response to the request from the searcher 22 to the key medium 30 within the area in which the NFC communication can be performed to notify the unique ID. Specifically, for example, when a ten-digit ID is transmitted from the key medium 30, the part of the unique ID corresponds to several digits (for example, 4 digits) of the transmitted ten-digit ID. Because the several digits correspond to information indicating that the unique ID is a random ID, the searcher 22 can judge whether or not the unique ID transmitted from the key medium 30 is a random ID, on the basis of the several digits.

When the unique ID is a random ID, the notifier 23 notifies the control unit 10 of the random ID. Accordingly, even when the key medium 30 does not have a unique ID, the communication control system 1 can authenticate the key medium 30 in a short time. Thus, the control unit 10 can instruct the key unit 2D to be switched from either the locked state or the unlocked state to the other.

In the present embodiment, the notifier 23 is configured not to notify the control unit 10 of the unique ID in a case where the unique ID is not a random ID. As a result, unnecessary communication can be prevented, and arithmetic processing of the control unit 10 due to such communication can be prevented. Therefore, power consumption in the control unit 10 can be reduced.

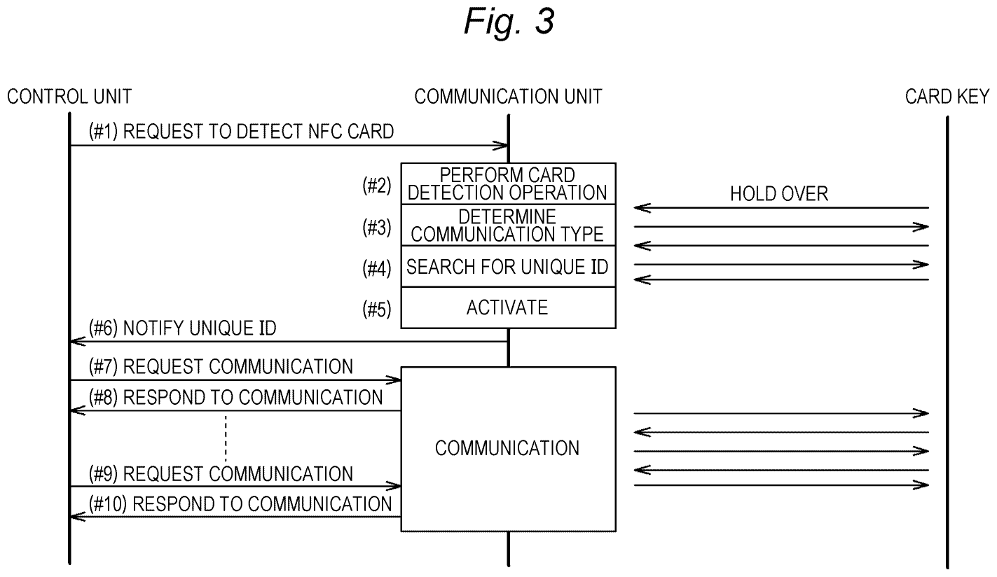

FIG. 3 shows a state of communication performed between the control unit 10 and the communication unit 20. The control unit 10 requests the communication unit 20 to detect an NFC card (here, a card key) (#1). This request is made, for example, at predetermined intervals or when a certain condition, such as an engine not running and a door being closed, is satisfied. The communication unit 20 performs NFC card detection operation in response to the detection request from the control unit 10 (#2). When the card key is held over the communication unit 20 in this state, the communication unit 20 determines a communication type of the held card key (#3) (that is, it is determined how many stages, such as Type-A, Type-B, and Type-F, the communication type is).

When the communication unit 20 determines the communication type of the card key, the searcher 22 searches for a unique ID that matches the unique ID (registered unique ID) stored in the second storage 21 (#4). When a unique ID that matches the unique ID (registered unique ID) stored in the second storage 21 is searched for, the card key (unique ID) is activated (#5). Then, the notifier 23 notifies the control unit 10 of the searched unique ID (#6). Thereafter, communication and response are maintained between the control unit 10 and the communication unit 20 (#7 to #10). At this time, the communication unit 20 also communicates with the card key.

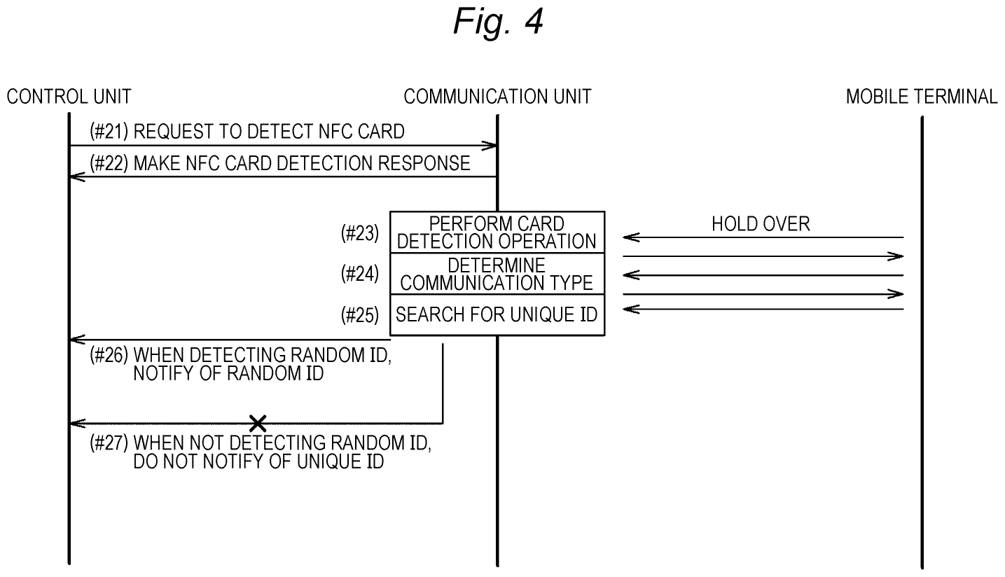

FIG. 4 shows a state of communication performed between the control unit 10 and the communication unit 20 in a case where the key medium 30 is not a card key. The control unit 10 requests the communication unit 20 to detect an NFC card (here, a card key) (#21). In response to this request, the communication unit 20 makes an NFC card detection response to the control unit 10 (#22). The communication unit 20 performs NFC card detection operation in response to the detection request from the control unit 10 (#23). When a mobile terminal is held over the communication unit 20 in this state, the communication unit 20 determines a communication type of the held mobile terminal (#24).

When the communication unit 20 determines the communication type of the mobile terminal, the searcher 22 searches for the unique ID (#25). When a random ID is detected as a result of searching for the unique ID, the notifier 23 notifies the control unit 10 of the random ID searched for, to activate NFC communication with the mobile terminal, and then communication and response are maintained (not shown in FIG. 4) (#26). Meanwhile, in a case where a random ID is not detected, the notifier 23 does not notify the control unit 10 (#27).

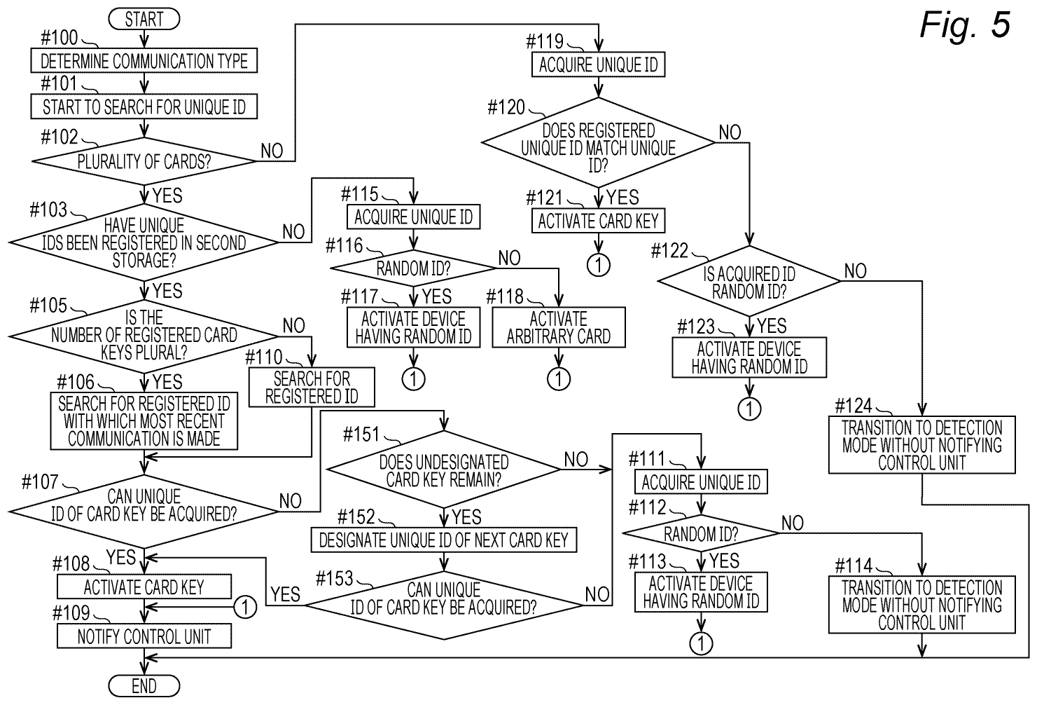

Next, processing in the communication unit 20 will be described with reference to FIG. 5. In particular, FIG. 5 shows processing in a case where the communication unit 20 is provided on the door handle 2C. When the key medium 30 is held over, the communication unit 20 determines the communication type (#100). When the determination of the communication type is completed, the search for the unique ID is started (#101). In a case where a plurality of key media 30 are searched for (#102: Yes) and unique IDs have been registered in the second storage 21 (#103: Yes), and where the number of registered card keys is plural (#105: Yes), a unique ID (registered unique ID) with which a most recent communication is made is searched for (#106). When the unique ID is acquired (#107: Yes), the card key is activated (#108), and the control unit 10 is notified of the unique ID (#109).

In #105, in a case where the number of registered card keys is not plural (#105: No), a registered ID is searched for (#110), and the processing is continued from #107.

In #107, in a case where the unique ID is not acquired (#107: No) and an undesignated card key remains (#151: Yes), a unique ID of a next card key is designated (#152). In a case where the unique ID can be acquired (#153: Yes), the processing is continued from #108. When there is no undesignated card key remaining in #151 (#151: No) or when the unique ID cannot be acquired in #153 (#153: No), the unique ID is acquired (#111). In a case where the acquired unique ID is a random ID (#112: Yes), a device having the random ID is activated (#113), and the control unit 10 is notified of the random ID (#109). In #112, in a case where the acquired unique ID is not a random ID (#112: No), a mode transitions to a detection mode without notifying the control unit 10 of an ID (#114).

In #103, in a case where the unique ID has not been registered in the second storage 21 (#103: No), the unique ID is acquired (#115). In a case where the acquired unique ID is a random ID (#116: Yes), a device having the random ID is activated (#117), and the control unit 10 is notified of the random ID (#109). In #116, in a case where the acquired unique ID is not a random ID (#116: No), an arbitrary card is activated without notifying the control unit 10 of an ID (#118).

In #102, in a case where the number of key media 30 searched for is not plural (#102: No), the unique ID to be searched for is acquired (#119). In a case where the unique ID (registered unique ID) matches the unique ID searched for (#120: Yes), the card key is activated (#121), and the control unit 10 is notified of the unique ID (#109).

In #120, in a case where the unique ID (registered unique ID) does not match the unique ID searched for (#120: No), and the acquired ID is a random ID (#122: Yes), a device having the random ID is activated (#123), and the control unit 10 is notified of the random ID (#109). In #122, in a case where the acquired ID is not a random ID (#122: No), the mode transitions to the detection mode without notifying the control unit 10 of an ID (#124).

After the control unit 10 being notified of the unique ID (specific unique ID or random ID) in #109, mutual authentication may be performed by NFC communication using a unique authentication key different from the unique ID stored in the key medium 30 to switch a function (for example, a door is switched from a locked state to an unlocked state, or vice versa).

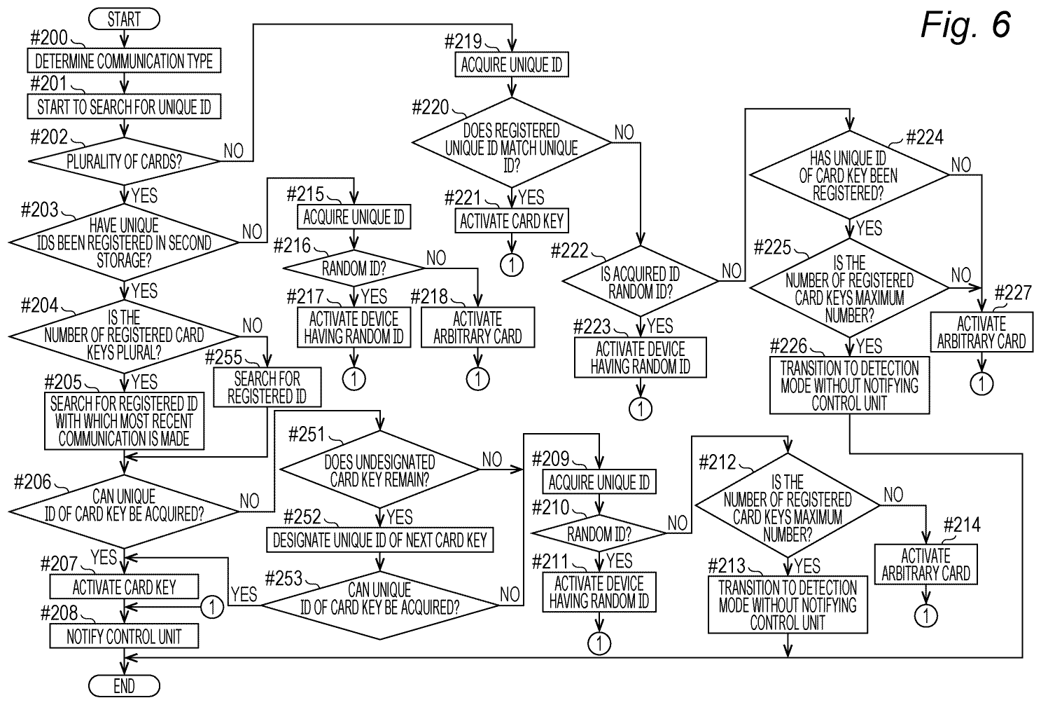

Next, processing in the communication unit 20 will be described with reference to FIG. 6. In particular, FIG. 6 shows processing in a case where the communication unit 20 is provided in the vehicle interior 2A. When the key medium 30 is held over, the communication unit 20 determines the communication type (#200). When the determination of the communication type is completed, the search for the unique ID is started (#201). In a case where a plurality of key media 30 are searched for (#202: Yes), unique IDs have been registered in the second storage 21 (#203: Yes), and the number of registered card keys is plural (#204: Yes), a unique ID (registered unique ID) with which a most recent communication is made is searched for (#205). When the unique ID is acquired (#206: Yes), the card key is activated (#207), and the control unit 10 is notified of the unique ID (#208).

In #204, in a case where the number of registered card keys is not plural (#204: No), a registered ID is searched for (#255), and the processing is continued from #206.

In #206, in a case where the unique ID is not acquired (#206: No) and an undesignated card key remains (#251: Yes), a unique ID of a next card key is designated (#252). In a case where the unique ID can be acquired (#253: Yes), the processing is continued from #207. When there is no undesignated card key remaining in #251 (#251: No) or when the unique ID cannot be acquired in #253 (#253: No), the unique ID is acquired (#209). In a case where the acquired unique ID is a random ID (#210: Yes), a device having the random ID is activated (#211), and the control unit 10 is notified of the random ID (#208). In #210, in a case where the acquired unique ID is not a random ID (#210: No), and the number of registered card keys is a maximum number (#212: Yes), the mode transitions to the detection mode without notifying the control unit 10 of an ID (#213). In #212, in a case where the number of registered card keys is not the maximum number (#212: No), an arbitrary card is activated (#214), and the control unit 10 is notified of the ID (#208).

In #203, in a case where the unique ID has not been registered in the second storage 21 (#203: No), the unique ID is acquired (#215). In a case where the acquired unique ID is a random ID (#216: Yes), a device having the random ID is activated (#217), and the control unit 10 is notified of the random ID (#208). In #216, in a case where the acquired unique ID is not a random ID (#216: No), an arbitrary card is activated (#218), and the control unit 10 is notified of the ID (#208).

In #202, in a case where the number of key media 30 searched for is not plural (#202: No), the unique ID to be searched for is acquired (#219). In a case where the unique ID (registered unique ID) matches the unique ID (#220: Yes), the card key is activated (#221), and the control unit 10 is notified of the unique ID (#208).

In #220, in a case where the unique ID (registered unique ID) does not match the unique ID (#220: No), and the acquired unique ID is a random ID (#222: Yes), a device having the random ID is activated (#223), and the control unit 10 is notified of the random ID (#208). In #222, in a case where the acquired unique ID is not a random ID (#222: No), the unique ID has been registered (#224: Yes), and the number of registered card keys is a maximum number (##225: Yes), the mode transitions to the detection mode without notifying the control unit 10 of an ID (#226). In a case where the unique ID has not been registered (#224: No) in #224, or in a case where the number of registered card keys is not the maximum number (#225: No) in #225, an arbitrary card is activated (#227), and the control unit 10 is notified of the ID (#208).

After the control unit 10 being notified of the unique ID (specific unique ID or random ID) in #208, mutual authentication may be performed by NFC communication using a unique authentication key different from the unique ID stored in the key medium 30 to switch a function (for example, the door is switched from the locked state to the unlocked state, or vice versa).

In the communication unit 20 of the communication control system 1, the above processing is executed. Of course, in the processing shown in FIGS. 5 and 6, the order of each processing can be changed as appropriate, or a part of the processing can be omitted.

### Other Embodiments

Next, other embodiments of a communication control system 1 will be described.

In the embodiment described above, it has been described that a communication unit 20 is provided on a door handle 2C, but the communication unit 20 may be provided on a part of a vehicle body such as a so-called B-pillar in a vehicle 2. In this case, the door handle 2C or B-pillar provided with the communication unit 20 may be a vehicle exterior antenna device, and the communication control system 1 may include the communication unit 20 provided on the door handle 2C and the B-pillar, and a control unit 10 provided on the vehicle 2. Therefore, the vehicle exterior antenna device preferably includes the communication unit 20 that performs NFC communication with a key medium 30 associated with a key unit 2D of the vehicle 2. The communication unit 20 preferably includes a second storage 21 (an example of a “storage”) that stores a unique ID of the key medium 30, a searcher 22 that searches for a unique ID that matches the unique ID (registered unique ID) stored in the second storage 21, when performing the NFC communication, and a notifier 23 that notifies the control unit 10 provided in the vehicle 2, when the unique ID that matches the unique ID (registered unique ID) stored in the second storage 21 is searched for.

In the embodiment described above, the communication unit 20 performs NFC communication with the key medium 30. However, the communication unit 20 may be configured to perform Bluetooth (registered trademark) Low Energy (BLE) communication or ultra-wide band (UWB) communication with the key medium 30.

In the embodiment described above, it has been described that the key medium 30 is a card key, but the key medium 30 may be a medium different from a card key as long as it is a medium using a fixed ID.

In the embodiment described above, it has been described that, in a case where a plurality of unique IDs (registered unique IDs) are stored in the second storage 21, among the plurality of unique IDs (registered unique IDs), the searcher 22 searches for the unique ID that matches the unique ID (registered unique ID) selected on the basis of communication information including at least either the number of communications with the key medium 30 or a communication history. For example, the searcher 22 may be configured to conduct a search in an order of most recent storage or least recent storage in the second storage 21, in a case where a plurality of unique IDs (registered unique IDs) are stored in the second storage 21.

In the embodiment described above, it has been described that the notifier 23 does not notify the control unit 10 of a unique ID in a case where the unique ID is not a random ID. However, the notifier 23 may be configured to notify the control unit 10 of the unique ID even in a case where the unique ID is not a random ID.

### Overview of Above Embodiments

Hereinafter, an overview of the communication control system 1 described above will be described.

(1) A communication control system 1 includes a communication unit 20 that performs NFC communication with a key medium 30 associated with a key unit 2D of a vehicle 2, and a control unit 10 that controls operation of the communication unit 20, in which the communication unit 20 includes a second storage 21 (storage) that stores a unique ID of the key medium 30, a searcher 22 that searches for a unique ID that matches the unique ID stored in the second storage 21, when performing the NFC communication, and a notifier 23 that notifies the control unit 10 when the unique ID that matches the unique ID stored in the second storage 21 is searched for.

That is, a communication control system includes: a communication unit that performs NFC communication with a key medium associated with a key unit of a vehicle; and a control unit that controls operation of the communication unit. The communication unit includes a storage that stores a unique ID of the key medium, a searcher that searches for a unique ID that matches the unique ID stored in the storage, when performing the NFC communication, and a notifier that notifies the control unit when the unique ID that matches the unique ID stored in the storage is searched for.

According to this configuration, the unique ID of the key medium 30 can be recognized in the communication unit 20, and thereafter, can be utilized as a judgment criterion for function switching. The communication unit 20 communicates solely with the key medium 30 having the unique ID that matches the unique ID stored in the second storage 21, so that communication time in the communication unit 20 can be shortened. Furthermore, it is not necessary to repeatedly activate and deactivate a plurality of key media 30 according to instructions from the control unit 10 to search for a predetermined key medium 30. Therefore, responsiveness is improved, and authentication can be performed in a short time. Moreover, because the communication time in the communication unit 20 is shortened, energization of electronic components that constitute the communication unit 20 is reduced. Therefore, lifetime of the electronic components can be extended as compared with a case where the energization of the electronic components is not reduced.

That is, with such a characteristic configuration, the unique ID of the key medium can be recognized in the communication unit, and thereafter, can be utilized as a judgment criterion for function switching. The communication unit communicates solely with the key medium having the unique ID that matches the unique ID stored in the storage, so that communication time in the communication unit can be shortened. Furthermore, it is not necessary to repeatedly activate and deactivate a plurality of key media according to instructions from the control unit to search for a predetermined key medium. Therefore, responsiveness is improved, and authentication can be performed in a short time. Moreover, because the communication time in the communication unit is shortened, energization of electronic components that constitute the communication unit is reduced. Therefore, lifetime of the electronic components can be extended as compared with a case where the energization of the electronic components is not reduced.

(2) In the communication control system 1 according to (1), in a case where a plurality of the unique IDs are stored in the second storage 21, among the plurality of unique IDs, the searcher 22 preferably searches for the unique ID that matches the unique ID selected on the basis of communication information including at least either the number of communications with the key medium 30 or a communication history.

That is, in the communication control system, in a case where a plurality of the unique IDs are stored in the storage, among the plurality of unique IDs, the searcher searches for the unique ID that matches the unique ID selected on the basis of communication information including at least either the number of communications with the key medium or a communication history.

According to this configuration, the unique ID is searched for according to previous use states. Therefore, it is easy to search for a unique ID of a key medium 30 possessed by a user who frequently uses the vehicle 2. Therefore, the communication time in the communication unit 20 can be shortened.

(3) In the communication control system 1 according to (1) or (2), the unique ID preferably includes a specific unique ID set for each the key medium 30 and a random ID generated every time the NFC communication is performed, the searcher 22 preferably requests the key medium 30 to notify the communication unit 20 of the unique ID of the key medium 30 and judges whether or not the unique ID is the random ID on the basis a part of a reception result in a case where the key medium 30 does not have the specific unique ID, and the notifier 23 preferably notifies the control unit 10 of the random ID in a case where the unique ID is the random ID.

That is, in the communication control system, the unique ID includes a specific unique ID set for each the key medium and a random ID generated every time the NFC communication is performed, the searcher requests the key medium to notify the communication unit of the unique ID of the key medium and judges whether or not the unique ID is the random ID on the basis a part of a reception result in a case where the key medium does not have the specific unique ID, and the notifier notifies the control unit of the random ID, in a case where the unique ID is the random ID.

According to this configuration, in a case where the key medium 30 does not have the unique ID, communication and authentication can be performed by using a mobile terminal having the random ID. Therefore, convenience can be improved.

(4) In the communication control system 1 according to (3), the notifier 23 preferably does not notify the control unit 10 of the unique ID in a case where the unique ID is not the random ID.

That is, in the communication control system, the notifier does not notify the control unit of the unique ID in a case where the unique ID is not the random ID.

According to this configuration, unnecessary communication can be prevented from being performed between the communication unit 20 and the control unit 10. Therefore, for example, the control unit 10 in a standby state is not woken up, by which power consumption can be reduced.

(5) In the communication control system, the control unit includes a control unit-side storage in which a unique ID of the key medium is stored, and the storage stores the unique ID stored in the control unit-side storage.

(6) A vehicle exterior antenna device includes a communication unit 20 that performs NFC communication with a key medium 30 associated with a key unit 2D of a vehicle 2, in which the communication unit 20 includes a second storage 21 that stores a unique ID of the key medium 30, a searcher 22 that searches for a unique ID that matches the unique ID stored in the second storage 21, when performing the NFC communication, and a notifier 23 that notifies the control unit 10 provided on the vehicle 2, when the unique ID that matches the unique ID stored in the second storage 21 is searched for.

That is, a vehicle exterior antenna device includes a communication unit that performs NFC communication with a key medium associated with a key unit of a vehicle. The communication unit includes a storage that stores a unique ID of the key medium, a searcher that searches for a unique ID that matches the unique ID stored in the storage, when performing the NFC communication, and a notifier that notifies the control unit provided on the vehicle, when the unique ID that matches the unique ID stored in the storage is searched for.

According to this configuration also, the unique ID of the key medium 30 can be recognized in the communication unit 20, and thereafter, can be utilized as a judgment criterion for function switching. The communication unit 20 communicates solely with the key medium 30 having the unique ID that matches the unique ID stored in the second storage 21, so that communication time in the communication unit 20 can be shortened. Furthermore, it is not necessary to repeatedly activate and deactivate a plurality of key media 30 according to instructions from the control unit 10 to search for a predetermined key medium 30. Therefore, responsiveness is improved, and authentication can be performed in a short time.

That is, even with such a characteristic configuration, as in the communication control system described above, the unique ID of the key medium can be recognized in the communication unit, and then, can be utilized as a judgment criterion for function switching. The communication unit communicates solely with the key medium having the unique ID that matches the unique ID stored in the storage, so that communication time in the communication unit can be shortened. Furthermore, it is not necessary to repeatedly activate and deactivate a plurality of key media according to instructions from the control unit to search for a predetermined key medium. Therefore, responsiveness is improved, and authentication can be performed in a short time.

The technology according to the present disclosure may be used in a communication control system that performs NFC communication.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A communication control system comprising:
a communication unit that performs NFC communication with a key medium associated with a key unit of a vehicle; and
a control unit that controls operation of the communication unit, wherein
the communication unit includes a storage that stores a unique ID of the key medium, a searcher that searches for a unique ID that matches the unique ID stored in the storage, when performing the NFC communication, and a notifier that notifies the control unit when the unique ID that matches the unique ID stored in the storage is searched for.

2. The communication control system according to claim 1,
wherein, in a case where a plurality of the unique IDs are stored in the storage, among the plurality of unique IDs, the searcher searches for the unique ID that matches the unique ID selected on the basis of communication information including at least either the number of communications with the key medium or a communication history.

3. The communication control system according to claim 1,
wherein the unique ID includes a specific unique ID set for each the key medium and a random ID generated every time the NFC communication is performed,
the searcher requests the key medium to notify the communication unit of the unique ID of the key medium and judges whether or not the unique ID is the random ID on the basis a part of a reception result in a case where the key medium does not have the specific unique ID, and
the notifier notifies the control unit of the random ID, in a case where the unique ID is the random ID.

4. The communication control system according to claim 3, wherein the notifier does not notify the control unit of the unique ID in a case where the unique ID is not the random ID.

5. The communication control system according to claim 1, wherein
the control unit includes a control unit-side storage in which a unique ID of the key medium is stored, and
the storage stores the unique ID stored in the control unit-side storage.

6. The communication control system according to claim 2,
wherein the unique ID includes a specific unique ID set for each the key medium and a random ID generated every time the NFC communication is performed,
the searcher requests the key medium to notify the communication unit of the unique ID of the key medium and judges whether or not the unique ID is the random ID on the basis a part of a reception result in a case where the key medium does not have the specific unique ID, and
the notifier notifies the control unit of the random ID, in a case where the unique ID is the random ID.

7. The communication control system according to claim 6, wherein the notifier does not notify the control unit of the unique ID in a case where the unique ID is not the random ID.

8. The communication control system according to claim 2, wherein
the control unit includes a control unit-side storage in which a unique ID of the key medium is stored, and
the storage stores the unique ID stored in the control unit-side storage.

9. A vehicle exterior antenna device comprising a communication unit that performs NFC communication with a key medium associated with a key unit of a vehicle, wherein
the communication unit includes a storage that stores a unique ID of the key medium, a searcher that searches for a unique ID that matches the unique ID stored in the storage, when performing the NFC communication, and a notifier that notifies the control unit provided on the vehicle, when the unique ID that matches the unique ID stored in the storage is searched for.
